(19) United States
(12) Patent Application Publication
(10) Pub. No.: US 2019/0188747 A1
(43) Pub. Date: Jun. 20, 2019

(54) REWARD OPTIMIZATION THROUGH REAL TIME AUTHORIZATION PROCESSING

(71) Applicant: MasterCard International Incorporated, Purchase, NY (US)

(72) Inventors: Prashant Sharma, Madison, NJ (US); Rajat Maheshwari, Singapore (SG); Manash Bhattacharjee, Jersey City, NJ (US)

(21) Appl. No.: 15/847,511

(22) Filed: Dec. 19, 2017

(51) Int. Cl. G06Q 30/02; G06Q 20/40; G06Q 20/22

(52) U.S. Cl. CPC G06Q 30/0226; G06Q 20/227; G06Q 20/401

(57) ABSTRACT

A method includes receiving a transaction authorization request message in a payment account system. A relevant database entry is accessed to determine whether another payment account belonging to the account holder should be inserted into the transaction authorization request message in place of the payment account originally submitted for use in the transaction. The purpose may be to maximize loyalty reward points or otherwise to gain a benefit available by using the other payment account rather than the originally submitted payment account.

### BACKGROUND

FIG. 1 is a block diagram that illustrates a conventional payment system 100.

The system 100 includes a payment device 102 (which may in some situations be a payment-enabled mobile device that stores a payment card account number and runs a payment applet; other form factors for the payment device, such as a fob, are also possible; also card-shaped payment devices, including payment IC cards and magnetic stripe cards are widely used). The system 100 further includes a reader component 104 associated with a POS (point of sale) terminal 106. In some known manner the reader component 104 is capable of reading the payment card account number and other information from the payment device 102.

The reader component 104 and the POS terminal 106 may be located at the premises of a retail store and operated by a sales associate of the retailer for the purpose of processing retail transactions. The payment device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate to receive a transaction authorization request message (“authorization request”) for the transaction from the POS terminal 106. The acquirer computer 108 may route the authorization request via a payment network 110 (sometimes also referred to as a “card network”) to the server computer 112 operated by the issuer of a payment account that is associated with the payment device 102. A transaction authorization response message (“authorization response”) generated by the payment account issuer server computer 112 may be routed back to the POS terminal 106 via the payment network 110 and the acquirer computer 108.

One well known example of a payment network is referred to as the “Banknet” system, and is operated by Mastercard International Incorporated, which is the assignee hereof.

The payment account issuer server computer 112 may be operated by or on behalf of a financial institution (“FI”) that issues payment accounts to individual users and/or other entities. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment devices for initiating payment transactions by presenting an associated payment account number to the reader component of a POS terminal.

A typical payment system like that shown in FIG. 1 may also handle other types of transactions, including online shopping transactions in which the purchaser submits a payment account number and related data to an e-commerce website-hosting computer (not shown in FIG. 1). In such situations, the e-commerce computer may play a role similar to that of the POS terminal 106 in terms of initiating a transaction authorization request message for routing to the issuer 112 via the acquirer 108 (or a payment processor—not separately shown—acting for the acquirer) and the payment network 112.

In a payment system like that shown in FIG. 1, it is not uncommon for payment account holders to have two, three or more payment account cards issued (physically or digitally) to them. Often payment account holders are attracted to, and acquire a card account for, a payment account product because of loyalty rewards features of the payment account product. Many account holders are interested in maximizing the number of loyalty reward “points” that they receive, and those account holders may select card products for issuance to the holders on that basis. Some payment account products may, for example, be oriented to travel expenditures, and may offer triple points for each dollar spent on airline tickets, hotel rooms and rental cars. Other payment account products may be oriented to entertainment expenditures, and may offer triple points for spending at restaurants. Still other payment account products may be co-branded with an oil company and may offer substantial loyalty rewards for purchasing gasoline or services at a service station affiliated with the oil company in question.

Other features of a payment account product may include waiver of foreign transaction fees, cash-back rewards and/or a favorable level of loyalty rewards for reaching a particular dollar amount of spending on the card in a given month.

While an account holder may find it beneficial to obtain two, three or more payment cards, and to carry them with him/her for use in various situations, there nevertheless may be considerable complexity in keeping aware of the various benefits of the card products that the account holder carries. This may potentially lead to selection of the “wrong” card in the sense that the account holder may select a card for a particular transaction that does not provide the maximum benefit to the account holder as compared to another card that the account holder carries.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram illustrating a conventional payment card account system.

FIG. 2 is a block diagram of an embodiment of a payment card account system in accordance with some embodiments of the disclosure.

FIG. 3 is a block diagram illustrating a computer system that may play a role in the payment card account system of FIG. 2.

FIG. 4 is a block diagram illustrating another computer system that may play a role in the payment card account system of FIG. 2.

FIGS. 5 and 6 are flowcharts illustrating processes that may be performed in the system of FIG. 2 in accordance with some embodiments of the disclosure.

### DETAILED DESCRIPTION

In general, and for the purpose of introducing concepts of novel embodiments described herein, a payment account holder may enroll in an optimization system operated via a payment network. In the enrollment process, the optimization system receives information about the account holder's payment accounts and the various rewards or other benefits associated with each of the payment accounts. When the account holder engages in a payment account transaction, including selection of one of the enrolled payment accounts, the optimization system may examine the transaction (as represented in a transaction authorization request) and the available benefits from the enrolled payment account(s) not selected for the transaction. If the payment account selected by the account holder does not provide the optimal available benefit to the account holder, then the optimization system selects another enrolled payment account that provides the best benefit(s) for the account holder for the particular transaction. The payment account selected by the optimization system is automatically substituted for the originally selected payment account in the transaction authorization request. The transaction then proceeds to be charged to the optimal payment account selected by the optimization system.

With this approach, the account holder need not keep in mind the various benefits offered by his/her payment accounts, and instead can rely on the optimization system to maximize the loyalty rewards or the other benefits for each transaction, regardless of the card account that the account holder presents for the transaction. With this arrangement, for example, the account holder may choose to carry with him/her only one of the enrolled cards, knowing that the card carried effectively will trigger charging of each transaction to the payment account most beneficial for the account holder.

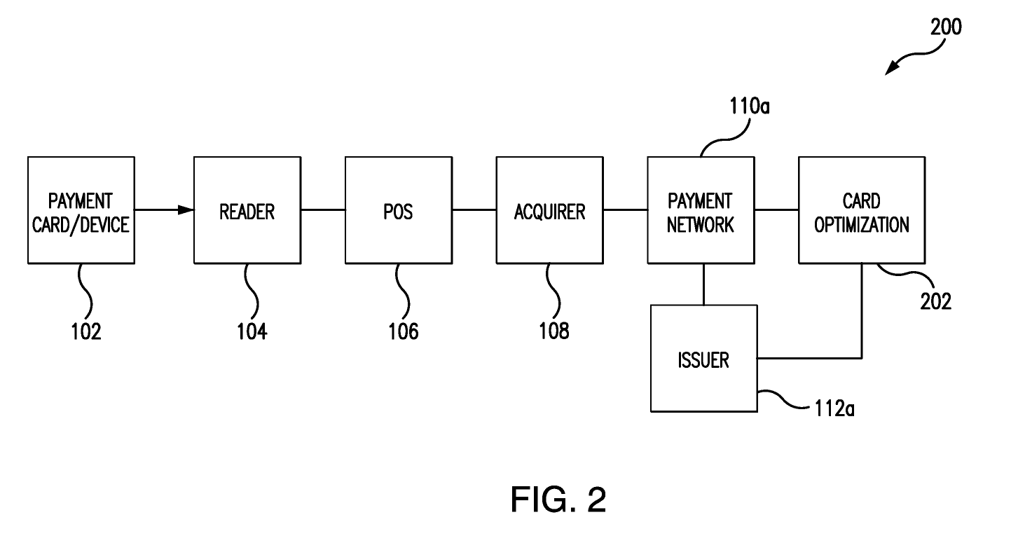

FIG. 2 is a block diagram of an embodiment of a payment card account system 200 in accordance with some embodiments of the disclosure.

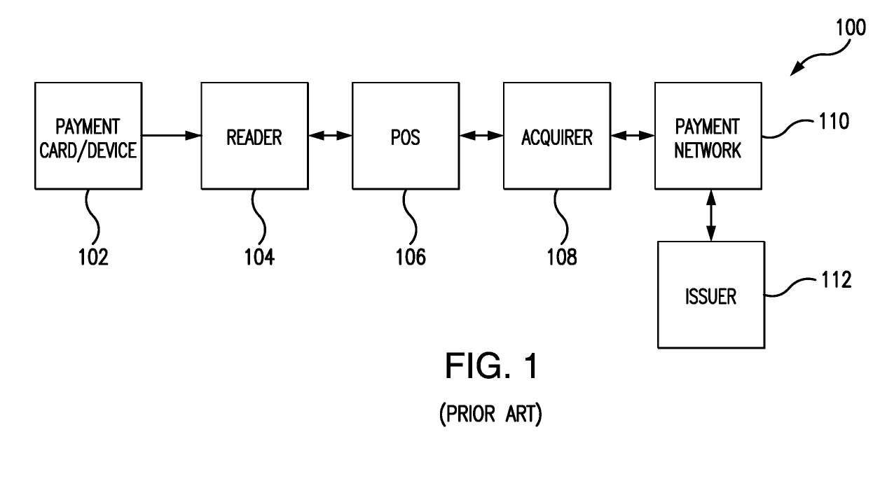

The payment card/device 102, card/device reader component 104, POS terminal 106 and transaction acquirer 108 as shown in FIG. 1 are also shown in FIG. 2; these elements may perform the same functions ascribed to them in connection with the above description of FIG. 1. The payment card account system 200 also includes a payment network 110a. The payment network 110a may provide similar functionality as described in connection with FIG. 1 regarding the payment network 110; in addition the payment network 110a may provide additional functionality in accordance with teachings of this disclosure, as described herein. The payment card account system 200 also includes an account issuer computer 112a. The account issuer computer 112a may provide the functionality ascribed to the account issuer 112 as described above in connection with FIG. 1; in addition the account issuer computer 112a may provide additional functionality in accordance with teachings of this disclosure as described herein.

Still further, the payment card account system 200 may include a card optimization computer system 202. The card optimization computer system 202 may be in communication with the payment network 110a and may provide account holder benefit optimization functionality in accordance with teachings of this disclosure, as described herein. In some embodiments, the card optimization computer system 202 may be operated by the same entity that operates the payment network 110a, or by an affiliate thereof. In some embodiments, there may be overlap between computing resources that implement the payment network 110a and the card optimization computer system 202.

It will be understood from FIG. 2 that the transaction acquirer 108 and the account issuer computer 112a are both in communication, at least from time to time, with the payment network 110a. Moreover, it should be understood that the components of the system 200 as depicted in FIG. 2 are only those that are needed for processing a single transaction. A system 200 may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment devices for initiating payment transactions by presenting an associated payment account number to the reader component of a POS terminal. Like the system 100 depicted in FIG. 1, the system 200 of FIG. 2 may also support e-commerce transactions and other types of transactions typically handled in a payment account system.

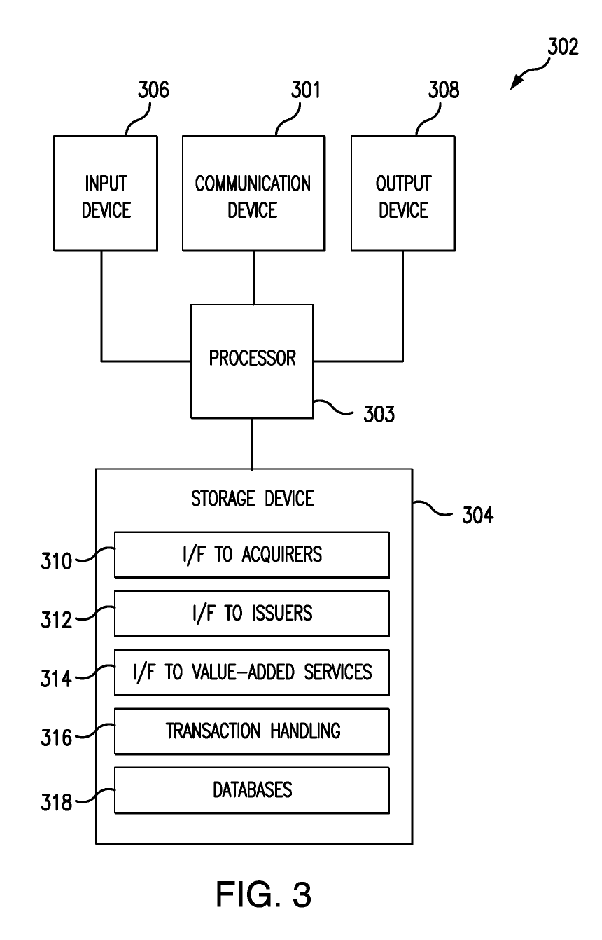

FIG. 3 is a block diagram of an example computer system 302 that may perform some or all of the functions of the payment network 110a shown in FIG. 2. The computer system 302 may be referred to as a “payment network computer system.” Although the payment network computer system 302 is depicted as a stand-alone component, some or all of the functions ascribed to it may be performed by a computer system network and/or other components operated by, or associated with, the payment network 110a.

Referring again to FIG. 3, the payment network computer system 302 may, in its hardware aspects, resemble a typical server computer and/or mainframe computer, but may be controlled by software to cause it to function as described herein. In addition, the payment network computer system 302 may be designed as a special purpose computer, and thus specially configured to perform the functions described herein.

The payment network computer system 302 may include one or more computer processor(s) 303 operatively coupled to a communication device 301, a storage device 304, an input device 306 and an output device 308. The communications device 301, the storage device 304, the input device 306 and the output device 308 may all be in communication with and/or operably connected to the processors 303. The processors 303 operate to execute processor-executable steps, contained in program instructions described below, so as to control the payment network computer system 302 to provide desired functionality.

Communication device 301 may be used to facilitate communication with, for example, other devices (such as other components of the system 200). Communication device 301 may comprise numerous communication ports (not separately shown), to allow the payment network computer system 302 to communicate simultaneously with a number of other computers and/or other devices, including communications as required to simultaneously handle numerous interactions which may be associated with numerous transactions.

Input device 306 may comprise one or more of any type of peripheral device typically used to input data into a computer. For example, the input device 306 may include a keyboard and a mouse. Output device 308 may comprise, for example, a display and/or an audio speaker, and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as flash memory and the like. Any one or more of such information storage devices may be considered to be a non-transitory computer-readable storage medium or a computer usable medium or a memory.

Storage device 304 stores one or more programs for controlling the payment network computer system 302. The programs comprise program instructions (which may be referred to as computer readable program code means) that contain processor-executable process steps of the payment network computer system 302, executed by the processor(s) 303 to cause the payment network computer system 302 to function as described herein.

The programs may include one or more conventional operating systems (not shown) that control the processor(s) 303 so as to manage and coordinate activities and sharing of resources in the payment network computer system 302, and to serve as a host for application programs (described below) that run on the payment network computer system 302.

The programs stored in the storage device 304 may include, for example, a software interface 310 that facilitates communications between the payment network computer system 302 and computers operated by transaction acquirers. The programs stored in the storage device 304 may further include a software interface 312 that facilitates communications between the payment network computer system 302 and computers operated by account issuers.

Another program that may be stored in the storage device 304 is a software interface 314 that facilitates communications between the payment network computer system 302 and one or more computers that provide value-added services in connection with transactions in the payment card account system 200. One of such value-added services computers may be the card optimization computer system 202.

The storage device 304 may also store a transaction handling application program 316. The transaction handling application program 316 may control the processor(s) 303 to enable the payment network computer system 302 to handle numerous payment account system transactions routed to and through the payment network 110a. As discussed below, the transaction handling by the payment network computer system 302 may include interaction with the card optimization computer system 202 to facilitate card account optimization processing as described herein.

The storage device 304 may also store, and the processor(s) 303 may also execute, other programs, which are not shown. For example, such programs may include communications software and one or more reporting applications. The latter program(s) may respond to requests from system administrators, for example, for reports on the activities performed by the payment network computer system 302. The other programs may also include, for example, device drivers, database management software, and the like.

The storage device 304 may also store one or more databases 318 that may be required for operation of the payment network computer system 302.

It should be understood that other computerized components of the system 200 may be constituted by computer hardware having the same type of components and/or hardware architecture as described herein with reference to FIG. 3.

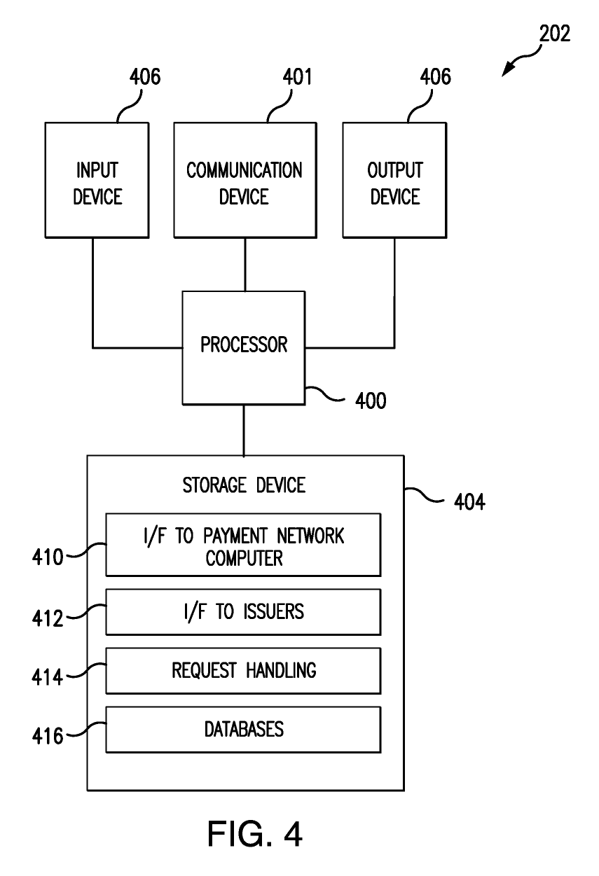

It is also the case that the card optimization computer system 202 may have the same types of components and/or hardware architecture as shown in FIG. 3. Reference is now made to FIG. 4, which is a block diagram representation of the card optimization computer system 202. Thus, the card optimization computer system 202 may include one or more computer processor(s) 400 operatively coupled to a communication device 401, a storage device 404, an input device 406 and an output device 408. The communications device 401, the storage device 404, the input device 406 and the output device 408 may all be in communication with and/or operably connected to the processor 400. The processor 400 operates to execute processor-executable steps, contained in program instructions described below, so as to control the card optimization computer system 202 to provide desired functionality.

Storage device 404 stores one or more programs for controlling the card optimization computer system 202. The programs comprise program instructions (which may be referred to as computer readable program code means) that contain processor-executable process steps of the card optimization computer system 202, executed by the processor 400 to cause the card optimization computer system 202 to function as described herein.

The programs may include one or more conventional operating systems (not shown) that control the processor 400 so as to manage and coordinate activities and sharing of resources in the card optimization computer system 202, and to serve as a host for application programs (described below) that run on the card optimization computer system 202.

The programs stored in the storage device 404 may include, for example, a software interface 410 that facilitates communications between the card optimization computer system 202 and the payment network 110a. The programs stored in the storage device 404 may further include a software interface 412 that facilitates communications between the card optimization computer system 202 and computers operated by account issuers.

The storage device 404 may also store a request handling application program 414. The request handling application program 414 may control the processor 400 to enable the card optimization computer system 202 to handle requests for value-added services transmitted to the card optimization computer system 202 from the payment network 110a. Details of functionality provided by the request handling application program 414 will be described below.

The storage device 404 may also store, and the processor 400 may also execute, other programs, which are not shown. For example, such programs may include communications software and one or more reporting applications. The latter program(s) may respond to requests from system administrators, for example, for reports on the activities performed by the card optimization computer system 202. The other programs may also include, for example, device drivers, database management software, and the like.

The storage device 404 may also store one or more databases 416 that may be required for operation of the card optimization computer system 202.

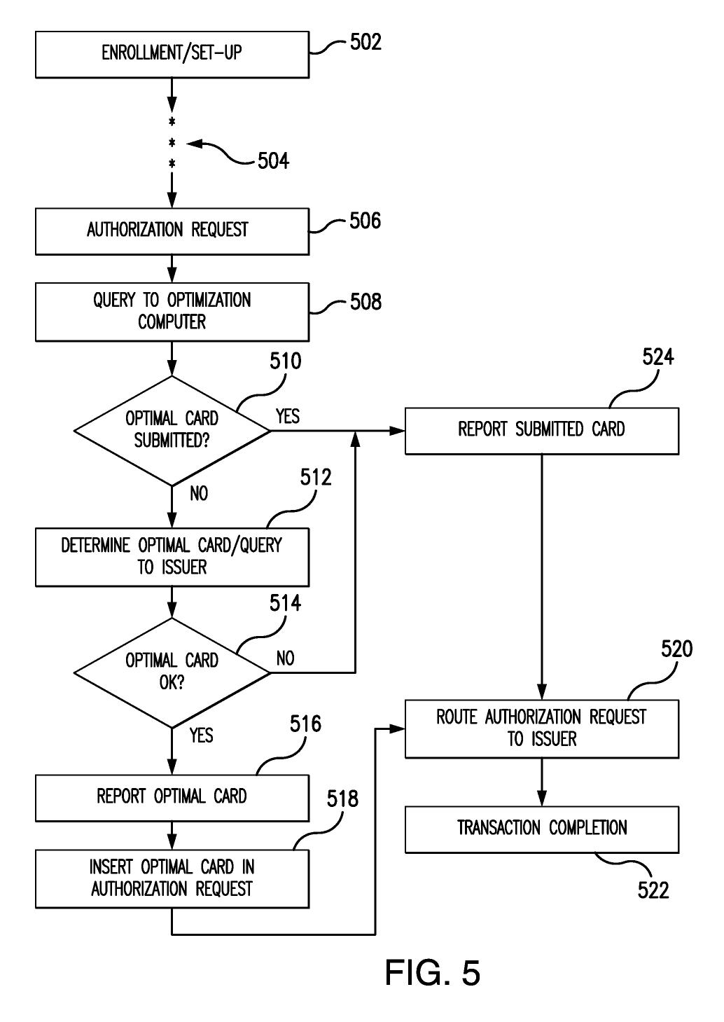

FIG. 5 is a flow chart that illustrates a process that may be performed in the system 200 in accordance with aspects of the present disclosure.

Block 502 in FIG. 5 represents an enrollment and/or set-up phase of an account holder's involvement with the services offered by the card optimization computer system 202. In some embodiments, the account holder may enroll in a card account optimization program offered via the account holder's bank (i.e., via the issuer of at least one of the account holder's payment accounts). In one embodiment, the account holder may have two or more payment accounts issued by the same issuer, and all having different characteristics when it comes to rewards/incentives for use. For example, the account holder may have a first payment account that is oriented toward travel-related purchases by providing triple points for purchases from airlines, hotels and car rental agencies. The account holder may have a separate payment account that provides triple points for transactions at restaurants. The account holder's third account from the same issuer may have an attractive cash-back feature. (Other types of payment accounts may offer favorable loyalty rewards at grocery stores or at gas stations.)

In some embodiments, the issuer may send an electronic message to the account holder inquiring whether the account holder wishes to enroll his/her card accounts in the optimization program. It may be the case that a “one-click” positive response from the account holder is all that is required for enrollment on the account holder's part. In response to the “one-click”, the issuer may communicate to the card optimization computer system 202 the account numbers (e.g., PANs—primary account numbers) for the account holder's accounts, along with data for each payment account that indicates the loyalty rewards and/or other features of the respective card account products under which the payment accounts are issued. The card optimization computer system 202 may then load the payment account numbers and data representing the corresponding features of the accounts into a database, to form a data entry for the account holder in the database.

It will now be assumed that after the enrollment/set-up activities of block 502, some time may elapse (perhaps hours or days), as represented by ellipsis 504. Thereafter, it will be further assumed that the account holder enrolled at 502 engages in a payment card account system transaction, resulting in generation and routing of an transaction authorization request message, which is indicated at block 506 and is routed from the POS device 106 (FIG. 2; or from an e-commerce server, which is not shown) to the acquirer 108 and on to the payment network 110a. Accordingly, the payment network 110a receives the transaction authorization request message. Using the payment account number and other data contained in the transaction authorization request message, the payment network 110a generates a query that it transmits (block 508) to the card optimization computer system 202. The purpose of the query is to allow the card optimization computer system 202 to determine whether there is a better choice available (as compared to the payment account selected/presented by the account holder for the transaction) in terms of the features or benefits of the various payment accounts of record in the card optimization computer system 202 for this account holder.

A decision block 510 follows block 508 in the process of FIG. 5. At decision block 510, the card optimization computer system 202 determines whether the payment account represented by the payment account number contained in the query (block 508) is the optimal payment account for the current transaction in terms of the rewards or other benefits from the various payment accounts enrolled with the card optimization computer system 202 for the account holder in question.

The decision made at block 510 by the card optimization computer system 202 may be based on data received by the card optimization computer system 202 in the query 508. For example, such data may include the merchant category code (MCC) and/or identification of the particular merchant involved in the current transaction. The data also includes the payment account number for the payment account selected by the account holder for the transaction. Using that account number, the card optimization computer system 202 may access the data entry that corresponds to the account holder. Data in that data entry may (as described above) be indicative of the various features and benefits of the account holder's payment accounts that are enrolled with the card optimization computer system 202. As also noted above, the payment account features/benefits may include various levels of loyalty rewards, which may depend on factors such as the MCC applicable to the current transaction. Based on the payment account features and benefits and data such as the MCC and/or the transaction amount, the card optimization computer system 202 may compare the benefits to the account holder that would accrue for each of the payment account enrolled with respect to the current transaction. The payment account referenced in the query 508 (i.e., the payment account selected by the account holder, such account also being referred to as the “submitted account”) will be determined by the card optimization computer system 202 to be the optimal payment card account for the transaction only if no other payment account enrolled for the account holder with the card optimization computer system 202 would provide better benefits. The determination by the card optimization computer system 202 that a particular card account is optimal or not optimal may be based on a complex set of rules that may, for example, trade off cash-back features against multiple reward point features. Alternatively, the determination by the card optimization computer system 202 at 510 may be based on a relatively simple rule that selects as optimal whatever card account provides the most loyalty points.

The transaction data considered at 510 may include an indication of what currency applies to the transaction. This data may guide the card optimization computer system 202 to determine as optimal an enrolled payment account having a feature that waives foreign transaction fees.

To give a concrete example, suppose that the submitted account offers only single reward points for the current transaction, while another enrolled card account for the account holder offers triple reward points (and no other card account offering is as good as the “triple points” account in terms of loyalty rewards). In this assumed case, the card optimization computer system 202 makes a negative determination at decision block 510, leading on to block 512, at which the card optimization computer system 202 determines which is the optimal enrolled card. In this assumed example, the card optimization computer system 202 determines that the “triple points” card account is optimal, and block 512 is followed by decision block 514.

At decision block 514, the card optimization computer system 202 determines whether the optimal card account determined at 512 is a viable account for use in the current transaction. For example, in order to do so, the card optimization computer system 202 may perform an API (application programming interface) call to the computer operated by the issuer of the optimal card, to pose a query as to whether sufficient credit is present in that payment account to support the current transaction. The account issuer may respond to the API call with an indication as to whether sufficient credit is available in the optimal account. If so, then the card optimization computer system 202 may make a positive determination at decision block 514, leading on to block 516.

At block 516, the card optimization computer system 202 may report the account number for the optimal card account back to the payment network 110a. That is, the card optimization computer system 202 may respond to the query at 508 by transmitting back to the payment network 110a the account number for the optimal card account, as determined at 512 and checked for viability at 514.

Block 518 may follow block 516 in the process of FIG. 5. At block 518, the payment network 110a may insert the payment account number reported at 516 into the transaction authorization request message in place of the payment account number originally included in the transaction authorization request message as generated, routed and received at 506.

Block 520 may follow block 518 in the process of FIG. 5. At block 520, the payment network 110a may route the transaction authorization request message in its current form (i.e., in this case, with the optimal payment account number inserted therein) to the issuer of the payment account that corresponds to the payment account number indicated in the transaction authorization request message in its current form.

Block 522 may follow block 520 in the process of FIG. 5. At block 522, the transaction is completed. In some embodiments, this may occur in accordance with conventional practices, with the account issuer processing the transaction authorization request message and issuing a transaction authorization response message for routing through the payment network 110a and the acquirer 108 to the POS terminal 106 (or to the e-commerce server—not shown—in another use case).

Considering again decision block 510 in FIG. 5, if a positive determination is made at that decision block (i.e., if the card optimization computer system 202 determines that the submitted payment account is the optimal payment account), then block 524 may follow decision block 510. At block 524, the card optimization computer system 202 may report the submitted payment account number back to the payment network 110a. That is, the card optimization computer system 202 may respond to the query at 508 by transmitting the submitted payment account number back to the payment network 110a. (In another embodiment, as an alternative to reporting back the submitted payment account number, the card optimization computer system 202 may provide a null response to the query at 508, thereby informing the payment network 110a that the submitted payment account is optimal and that no substitution of the payment account number is in order with respect to the current transaction authorization request message.)

Block 524 may be followed by the above-discussed blocks 520 and 522, resulting in the payment network routing the transaction authorization request message in its original form (also its current form) with the submitted payment account number, and the transaction being completed according to conventional practices.

Considering again decision block 514 in FIG. 5, if a negative determination is made at that decision block (i.e., if the card optimization computer system 202 determines that the optimal payment account is not viable for the current transaction, based on the response from the account issuer), then block 524—as discussed above—may follow decision block 514. As before, block 524 may be followed by blocks 520 and 522, as also discussed above in connection with block 524.

Assuming the process of FIG. 5 passes through the branch of blocks 516 and 518 on the way to blocks 520 and 522, then a positive result is that the account holder may receive a beneficial switching of the designated payment account to a payment account that provides greater benefits in connection with the transaction, such as a greater number of loyalty reward points. More generally, a process like that of FIG. 5 may permit the account holder to carry and present only one payment account card out of a number of different cards, while still getting the benefit, from transaction to transaction, of the optimal selection (by the card optimization computer system 202) from among the account holder's card accounts. In addition or alternatively, the account holder may be relieved from the complexity and “mental overhead” that would otherwise be entailed in keeping track of which card is best to use in each of a considerable variety of situations. In other words, life is made simpler for the holder of multiple card accounts.

It may also be attractive to account issuers to offer rewards optimization services (as described herein) or the like to their customers/payment account holders, due to the possible increase in customer satisfaction that may result.

The foregoing example has emphasized maximization of rewards points, but the decision-making by the card optimization computer system 202 need not be limited to this one dimension. Alternatively, for example, the card optimization computer system 202 may consider and prioritize cash-bank features when more beneficial or relevant than reward points; as another alternative, the card optimization computer system 202 may prioritize avoiding a foreign transaction fee when selecting among available enrolled payment accounts for a particular account holder and a particular transaction. Still further, if a card feature generously rewards a large balance of purchases in a single billing cycle, the card optimization computer system 202 may prioritize building the purchase balance for that card account.

In some embodiments, all of the enrolled cards may be issued by the same account issuer. However, that need not necessarily be the case. For example, the card optimization computer system 202 may be accessible by account holders for enrolling a number of different card accounts, not all of which need be issued by the same account issuer. Moreover, it need not necessarily be the case that all card accounts enrolled be issued under the same payment network brand. Where more than one payment network brand of account may be enrolled, a payment gateway or gateways (not shown) may exist to facilitate switching of transactions from one payment network to another (not shown).

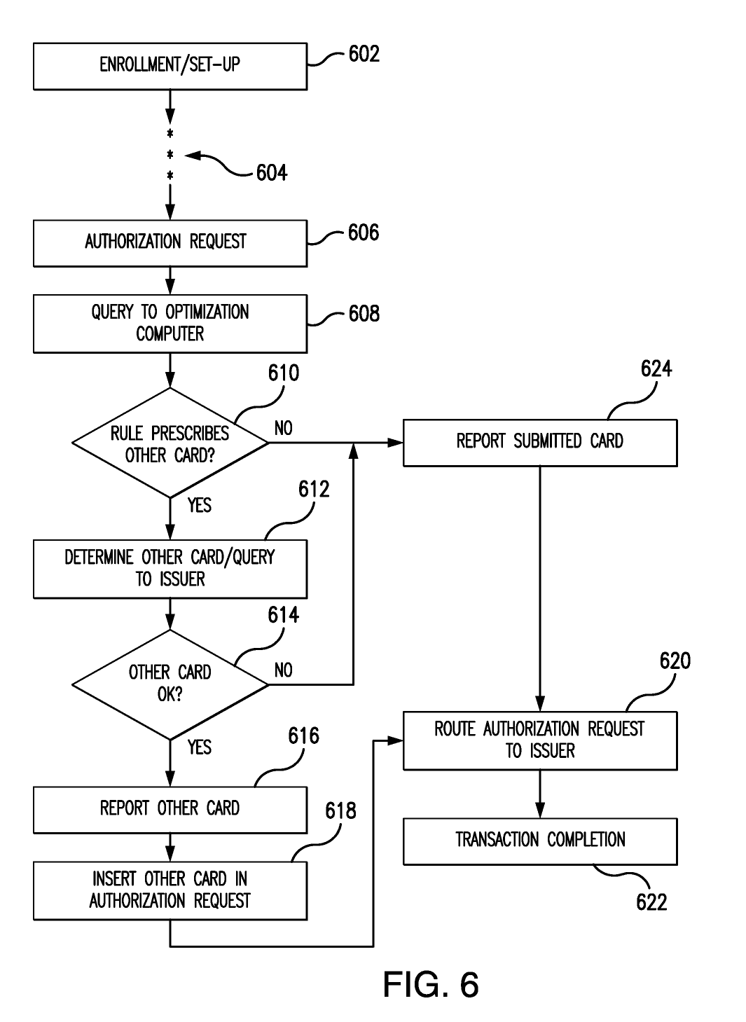

FIG. 6 is a flow chart that illustrates another process that may be performed in the system 200 according to aspects of the present disclosure. As a comparison of FIG. 6 with FIG. 5 will indicate, there are very substantial similarities between the respective processes illustrated in the two drawings. The process of FIG. 6 differs from the process of FIG. 5 mainly in that the process of FIG. 6 may allow an account holder to upload his/her preferred rule or rules regarding card account selection to the card optimization computer system 202 or a similar value-added-service computer (not separately shown). Thus, with the process of FIG. 6, during transaction authorization, a transaction authorization request message may trigger a query from the payment network 110a to the card optimization computer system 202 or a like device to have a rule-based determination on whether to substitute another enrolled payment account for the submitted payment account, with the rule(s) having been prescribed by the account holder.

Block 602 in FIG. 6 generally corresponds to block 502 as described above in connection with FIG. 5, except that block 602 also contemplates the account holder uploading at least one rule for application by the card optimization computer system 202 instead of the optimization process described in connection with FIG. 5. To give a concrete example, the account holder may have been advised by the account issuer that the card product corresponding to the account holder's account number XXXX-XXXX-XXXX-1234 will award 50,000 loyalty points if the account holder charges a total of $5,000 or more to that account during the current calendar quarter. To benefit from this special offer, the account holder may upload a rule that all transactions are to be charged to account number XXXX-XXXX-XXXX-1234 during the current calendar quarter.

Another possible rule may prescribe that all transactions above a certain monetary amount (or alternatively below a certain monetary amount) are to be charged to a given enrolled payment account. Still another possible rule may prescribe that all transactions for a certain MCC, or for a certain merchant, are to be charged to a given enrolled payment account.

As in FIG. 5, an ellipsis 604 is shown in FIG. 6, followed by blocks 606 and 608, which are parallel to blocks 506 and 508 of FIG. 5.

Continuing to refer to FIG. 6, a decision block 610 follows block 608. At decision block 610, the card optimization computer system 202 (or other value-added-services computer) determines whether an account-holder prescribed rule is in effect that calls for replacement of the submitted payment account with another enrolled payment account. If so, then the other enrolled card account is determined (block 612), and a determination (decision block 614) is made with respect to the viability of the other payment account, in similar fashion to decision block 514 in FIG. 5.

If the other payment account is found to be viable, then it is reported (block 616) and substituted in the current transaction authorization request message (block 618), in like fashion to blocks 516 and 518 in FIG. 5. The overall processing flow in FIG. 6 is similar to that of FIG. 5, and blocks 620, 622 and 624 in FIG. 6 are parallel to blocks 520, 522 and 524 in FIG. 5.

It should be recognized that the processes of FIGS. 5 and 6 can be combined, with an account-holder-defined rule applied if appropriate, and if not, then optimization processing may occur per the process of FIG. 5.

In optimization embodiments described herein, the decision making may be based on MCC or merchant data as contained in a typical transaction authorization request message. Alternatively, the merchant or merchant category may be detected via geo-location sensing via a mobile device carried by the account holder at the time of the transaction (i.e., on the merchant's premises).

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of at least some steps and/or omitting one or more steps.

As used herein and in the appended claims, the term “payment card system account” includes a credit card account or a deposit account that the account holder may access using a debit card. The terms “payment card system account” and “payment card account” and “payment system account” and “payment account” and “card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the terms “payment account number”, “payment account identifier” and “payment account indicator” are used interchangeably, and each of these terms encompasses PANs (primary account numbers) and/or payment tokens.

As used herein and in the appended claims, the term “payment card system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving a transaction authorization request message, the transaction authorization request message requesting authorization of a transaction, the transaction authorization request message including a first payment account identifier, the first payment account identifier representing a first payment account that belongs to an account holder;
accessing a database entry that relates to the account holder;
determining from the database entry that a second payment account offers an advantage for the account holder with respect to the transaction in comparison with the first payment account, said second payment account different from said first payment account and represented by a second payment account identifier different from the first payment account identifier, said second payment account belonging to the account holder;
confirming with an issuer of the second payment account that a status of the second payment account supports charging the transaction to the second payment account;
after the confirming step, substituting the second payment account identifier in the transaction authorization request message in place of the first payment account identifier; and
routing the transaction authorization request message, with the second payment account identifier included therein, to the issuer of the second payment account for authorization by the issuer of the second payment account.

2. The method of claim 1, wherein the first payment account was issued by the issuer of the second payment account.

3. The method of claim 1, wherein said determining step includes determining that said first payment account provides more loyalty reward points for the transaction than the first payment account.

4. The method of claim 3, wherein:
the transaction authorization request message includes a merchant category code (MCC) that pertains to a merchant involved in the transaction; and
the determining step is based in part on the MCC.

5. The method of claim 1, wherein:
the transaction authorization request message includes data that indicates a currency in which the transaction is being executed; and
said determining step includes determining that using the second payment account for the transaction avoids a foreign transaction fee.

6. The method of claim 1, wherein the database entry that relates to the account holder lists at least three payment accounts that belong to the account holder; said at least three payment accounts including said first payment account and said second payment account.

7. The method of claim 1, wherein said receiving and routing steps are performed by a payment network computer.

8. A method comprising:
receiving a transaction authorization request message, the transaction authorization request message requesting authorization of a transaction, the transaction authorization request message including a first payment account identifier, the first payment account identifier representing a first payment account that belongs to an account holder;
accessing a rule defined by the account holder, said rule prescribing use of a second payment account for the transaction; said second payment account different from said first payment account and represented by a second payment account identifier different from the first payment account identifier, said second payment account belonging to the account holder;
confirming with an issuer of the second payment account that a status of the second payment account supports charging the transaction to the second payment account;
after the confirming step, substituting the second payment account identifier in the transaction authorization request message in place of the first payment account identifier; and
routing the transaction authorization request message, with the second payment account identifier included therein, to the issuer of the second payment account for authorization by the issuer of the second payment account.

9. The method of claim 8, wherein the first payment account was issued by the issuer of the second payment account.

10. The method of claim 8, wherein said rule prescribes using said second payment account during a predetermined period of time.

11. The method of claim 8, wherein said rule prescribes using said second payment account for transactions with a predetermined category of merchants.

12. The method of claim 8, wherein said rule prescribes using said second payment account with a predetermined merchant.

13. The method of claim 8, wherein said rule prescribes using said second payment account for transactions above a predetermined monetary amount.

14. The method of claim 8, wherein said rule prescribes using said second payment account for transactions below a predetermined monetary amount.

15. The method of claim 8, wherein said receiving and routing steps are performed by a payment network computer.

16. An apparatus comprising:
a processor; and
a memory in communication with the processor, the memory storing program instructions, the processor operative with the program instructions to perform functions as follows:
receiving a transaction authorization request message, the transaction authorization request message requesting authorization of a transaction, the transaction authorization request message including a first payment account identifier, the first payment account identifier representing a first payment account that belongs to an account holder;
accessing a database entry that relates to the account holder;
determining from the database entry that a second payment account offers an advantage for the account holder with respect to the transaction in comparison with the first payment account, said second payment account different from said first payment account and represented by a second payment account identifier different from the first payment account identifier, said second payment account belonging to the account holder;
confirming with an issuer of the second payment account that a status of the second payment account supports charging the transaction to the second payment account;
after the confirming step, substituting the second payment account identifier in the transaction authorization request message in place of the first payment account identifier; and
routing the transaction authorization request message, with the second payment account identifier included therein, to the issuer of the second payment account for authorization by the issuer of the second payment account.

17. The apparatus of claim 16, wherein the first payment account was issued by the issuer of the second payment account.

18. The apparatus of claim 16, wherein said determining step includes determining that said first payment account provides more loyalty reward points for the transaction than the first payment account.

19. The apparatus of claim 18, wherein:
the transaction authorization request message includes a merchant category code (MCC) that pertains to a merchant involved in the transaction; and
the determining step is based in part on the MCC.

20. The apparatus of claim 16, wherein:
the transaction authorization request message includes data that indicates a currency in which the transaction is being executed; and
said determining step includes determining that using the second payment account for the transaction avoids a foreign transaction fee.
